(19) United States
(12) Patent Application Publication
(10) Pub. No.: US 2013/0238136 A1
(43) Pub. Date: Sep. 12, 2013

(54) SYSTEM AND METHOD FOR REMOTELY AND AUTOMATICALLY CONTROLLING BUILDING ENERGY FACILITIES

(71) Applicant: ELECTRONICS AND TELECOMMUNICATIONS RESEARCH INSTITUTE, Daejeon (KR)

(72) Inventors: Youn Kwae JEONG, Daejeon (KR); Il Woo LEE, Daejeon (KR)

(73) Assignee: Electronics and Telecommunications Research Institute, Daejeon (KR)

(21) Appl. No.: 13/790,905

(22) Filed: Mar. 8, 2013

(30) Foreign Application Priority Data
Mar. 9, 2012 (KR) 10-2012-0024468

(51) Int. Cl. G06F 1/28

(52) U.S. Cl. CPC G06F 1/28
USPC 700/275

(57) ABSTRACT

A system and method for remotely and automatically controlling building energy facilities is disclosed. An apparatus for remotely and automatically controlling building energy facilities may include a building facility interface to match control and alarm signals of a manual control panel installed in a building to manage energy used in a building facility and to control a switch of the manual control panel, a facility status information generator to convert the matched control and alarm signals to generate status information on the building facility, and a facility status controller to control the switch of the manual control panel based on the generated status information to remotely control an operation status of the building facility.

### CROSS-REFERENCE TO RELATED APPLICATION

This application claims the priority benefit of Korean Patent Application No. 10-2012-0024468, filed on Mar. 9, 2012, in the Korean Intellectual Property Office, the disclosure of which is incorporated herein by reference.

### BACKGROUND

1. Field of the Invention The present invention relates to a system and method for remotely and automatically controlling building energy facilities in which a manual control panel installed in a building to turn on and off a facility that is automated to remotely manage and control an energy facility of the building and to cut energy costs of the building.

2.Description of the Related Art

Currently, in most small and medium-sized buildings, a system operator manually turns on and off switches of manual control panels installed in the buildings in order to control operations of energy facilities, such as cooling, heating or air conditioning.

As exiting building energy facilities are run by a person manually turning on and off switches, operations involving waste of energy may be conducted or energy facilities may be even unnecessarily run to cause waste of energy. However, small and medium-sized buildings cannot adopt an expensive building automation system (BAS), which is employed in a large building, because of management costs and financial burdens in building a system. Thus, in an existing building, people are subject to an inconvenience of manipulating a switch to control a building facility, a building facility is not controlled if no one is present, a substantial waste of energy occurs when an unskilled person operates a building facility, and it is difficult to continuously conduct automatically control over a building facility.

Thus, there is a need for technology which enables automated manipulation of an existing manual control panel of a building facility and remote and automatic control over facilities in order to effectively control the building facilities, thus decreasing difficulties in operating the building facilities due to manual operations of the manual control panel and reducing costs in building a system, and realizes reduction of energy used in a building facility by adopting various energy-saving measures, such as building facility operation scheduling by a system.

### SUMMARY

Aspects of the present invention provide a system and a method for remotely and automatically controlling a building energy facility, wherein the system is configured to remotely and automatically control building energy facilities with low cost to enable remote and automatic control of a building facility based on facility operation scheduling without a person directly operating a manual control panel of the building facility, thereby reducing waste of energy in the building facility.

According to an aspect of the present invention, there is provided an apparatus for remotely and automatically controlling building energy facilities, the apparatus including a building facility interface to match control and alarm signals of a manual control panel installed in a building to manage energy used in a building facility and to control a switch of the manual control panel, a facility status information generator to convert the matched control and alarm signals to generate status information on the building facility, and a facility status controller to control the switch of the manual control panel based on the generated status information to remotely control an operation status of the building facility.

The building facility interface may include a building facility circuit matching unit to match the control and alarm signals of the building facility, a manual control panel switch controller to control the switch of the manual control panel based on control by the facility status controller, and a sensor/meter circuit matching unit to match circuits of a sensor and a meter associated with the building facility.

The apparatus may further include a facility status information storage/management unit to store and manage the generated status information.

The apparatus may further include a facility status information transmitter to transmit the generated status information to an apparatus for remotely and integratedly managing building energy facilities which conducts remote and integrated management of a plurality of apparatuses for remotely and automatically controlling building facilities, a facility status/control information transmission/reception protocol processor to process a protocol to transmit and receive the status information and control information to control the building facilities to and from the apparatus for remotely and integratedly managing the building energy facilities, and a cable/wireless network interface to transmit/receive the status information and the control information through a cable/wireless network.

According to an aspect of the present invention, there is provided an apparatus for remotely and integratedly managing building energy facilities, the apparatus including a cable/wireless network interface to transmit and receive status information on a building facility and control information to control the building facility to and from an apparatus for remotely and automatically controlling building energy facilities, the status information being generated by the apparatus for remotely and automatically controlling the building energy facilities matching control and alarm signals of a manual control panel installed in a building to manage energy used in the building facility, a facility status/control information transmission/reception protocol processor to process a protocol to receive the status information from the apparatus for remotely and automatically controlling the building energy facilities and to transmit the control information to the apparatus for remotely and automatically controlling the building energy facilities, a building facility operation scheduling processor to manage an operation plan of the building based on the received status information, a building facility alarm processor to process an alarm situation of the building facility based on the received status information, a manual control panel switch controller to generate the control information based on the operation plan and to control a switch of a manual control panel installed in the building based on the control information, a building facility operator interface to remotely manage the building facility, and a building facility status/control information record management database to manage a record of the status information and the control information.

According to an aspect of the present invention, there is provided a system for remotely and automatically controlling building energy facilities, the system including a plurality of apparatuses for remotely and automatically controlling building energy facilities to generate status information on a building facility by matching control and alarm signals of a manual control panel installed in a building in order to manage energy used in the building facility, and an apparatus for remotely and integratedly managing building energy facilities to control a switch of the manual control panel installed in the building by receiving the generated status information, managing an operation plan of the building based on the status information, generating control information based on the operation plan, and transmitting the control information to the apparatuses for remotely and automatically controlling the building energy facilities.

According to an aspect of the present invention, there is provided a method for remotely and automatically controlling building energy facilities which control a building facility to manage energy used in a building, the method including matching control and alarm signals of a manual control panel installed in the building, converting the matched control and alarm signals and generating status information on the building facility, and remotely controlling an operation status of the building facility based on the generated status information.

As described above, a system for remotely and automatically controlling building energy facilities according to the present invention may remotely and automatically performing a function of a manual control panel in a building environment where a building automation system (BAS) is not built without a person directly controlling a building facility through the manual control panel of the facility, remotely control the building facility even when an operator is not present in the site, and automatically operate the building facility based on an operation plan.

Further, the system may remotely and automatically control an existing manual control panel without building an expensive direct digital controller (DDC) or BAS having sophisticated functions and construct a facility automation system enabling planned facility operation, which is hard to be realized by a manual control unit, thereby remarkably reducing construction costs.

In addition, the system has a simple structure capable of remotely and automatically controlling and managing a manual control panel of an existing building facility and may be applied to small and medium-sized buildings with low cost to substantially reduce waste of energy in a building facility.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a system for remotely and automatically controlling building energy facilities according to an embodiment of the present invention;

FIG. 2 illustrates a detailed configuration of an apparatus for remotely and automatically controlling building energy facilities according to an embodiment of the present invention;

FIG. 3 illustrates a detailed configuration of a building facility interface according to an embodiment of the present invention;

FIG. 4 illustrates a detailed configuration of an apparatus for remotely and integratedly managing building energy facilities according to an embodiment of the present invention; and

FIG. 5 is a flowchart illustrating a method for remotely and automatically controlling building energy facilities according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

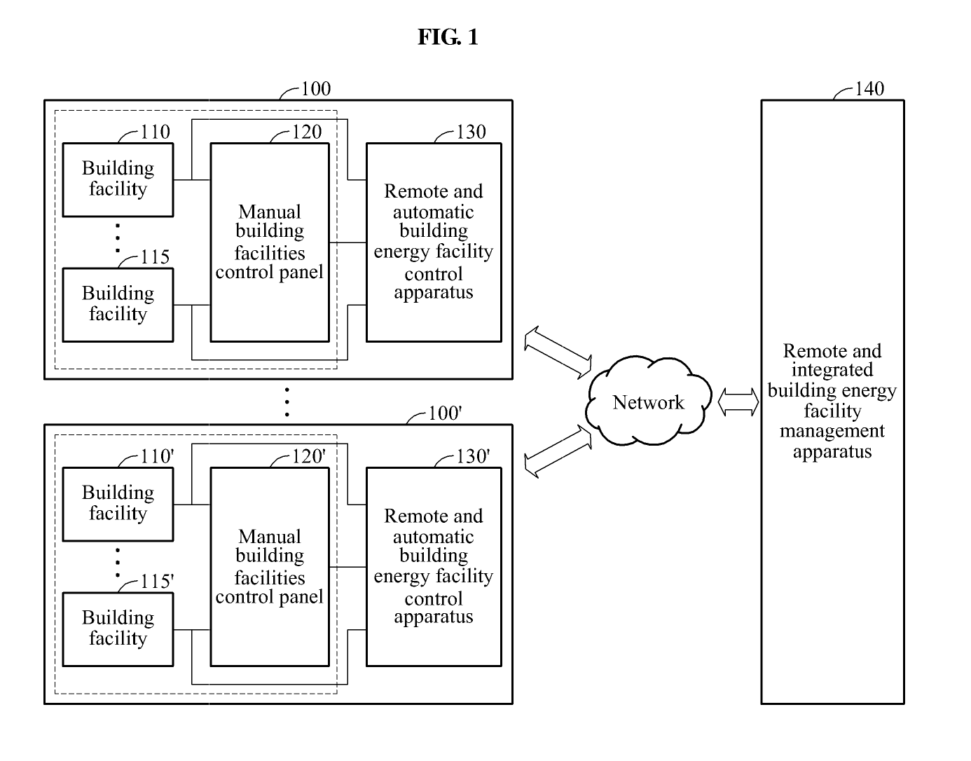

FIG. 1 is a block diagram illustrating a system for remotely and automatically controlling building energy facilities according to an embodiment of the present invention.

Referring to FIG. 1, the system for remotely and automatically controlling the building energy facilities includes apparatuses for remotely and automatically controlling building energy facilities, hereinafter “remote and automatic control apparatuses”, 130 and 130′ to automatically control functions of manual control panels 120 and 120′ manually manipulating existing building facilities 110, 110′, 115 and 115′ without engagement of a person and an apparatus for remotely and integratedly managing building energy facilities, hereinafter “a remote and integrated management apparatus”, 140 to remotely conduct integrated control over the manual control panels 120 and 120′ of the building facilities 110, 110′, 115 and 115′ of a plurality of buildings 110 and 110′ and to provide a method of effectively operating the control panels 120 and 120′ based on a use plan of the building facilities 110, 110′, 115 and 115′.

The remote and automatic control apparatus 130 and 130′ installed in the respective buildings 110 and 110′ match control and alarm signals of the manual control panels 120 and 120′ installed in the buildings to generate status information on the building facilities in order to manage energy used in the building facilities 110, 110′, 115 and 115′.

The remote and integrated management apparatus 140 receives the status information from the remote and automatic control apparatus 130 and 130′ through a network, manages operation plans of the relevant buildings based on the status information, generates control information based on the operation plans, and transmits the control information to the relevant remote and automatic control apparatus 130 and 130′, thereby controlling switches of the manual control panels 120 and 120′ installed in the relevant buildings.

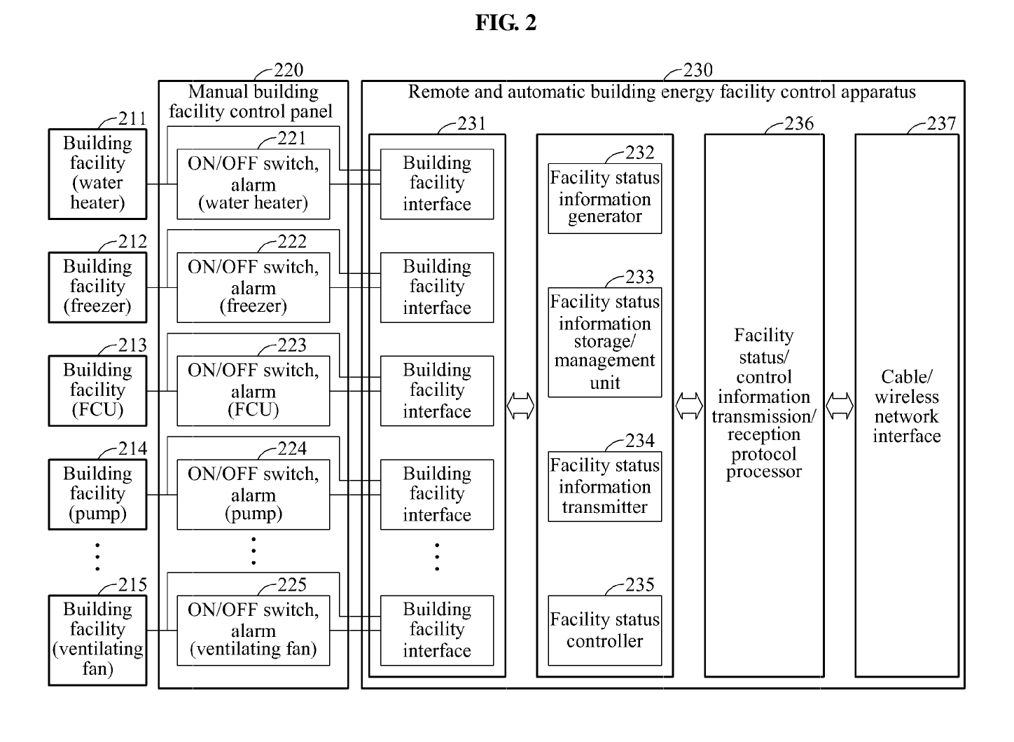

FIG. 2 illustrates a detailed configuration of a remote and automatic building energy facility control apparatus according to an embodiment of the present invention. Hereinafter, the remote and automatic building energy facility control apparatus will be described in detail with reference to FIG. 2.

Referring to FIG. 2, the remote and automatic building energy facility control apparatus 230 may include building facility interfaces 231, a facility status information generator 232, a facility status information storage/management unit 233, a facility status information transmitter 234, a facility status controller 235, a facility status/control information transmission/reception protocol processor 236, and a cable/wireless network interface 237.

The building facility interfaces 231 serve to match control and alarm signals of a manual control panel 220 installed in a building to manage energy used in building facilities 211 to 215 and to control switches of the manual control panel 220.

For example, as shown in FIG. 2, the building facilities may include a water heater 211, a freezer 212, a FCU 213, a pump 214 and a ventilating fan 215, and the manual control panel 220 may include ON/OFF switches and alarms 221 to 225 to control the building facilities 211 to 215. In this case, the building facility interfaces 231 are respectively connected to the building facilities 211 to 215 and the ON/OFF switches and the alarms 221 to 225 of the manual control panel 220 to match control and alarm signals of the relevant building facilities and the switches of the manual control panel.

The facility status information generator 232 receives and converts the control and alarm signals matched by the building facility interface 231 to generate status information on the building facilities.

The facility status information storage/management unit 233 stores and manages the status information generated by the facility status information generator 232.

The facility status information transmitter 234 transmits the status information generated by the facility status information generator 232 to a remote and integrated management apparatus which remotely and integratedly manages a plurality of remote and automatic control apparatus.

The facility status controller 235 controls the switches of the manual control panel based on the status information to remotely control an operation status of the building facilities.

When control information requesting control over the manual control panel 220 is received from the remote and integrated building energy facility management apparatus, the facility status controller 235 may control the relevant building facilities 211 to 215 based on the control information through the building facility interfaces 231.

The facility status/control information transmission/reception protocol processor 236 processes a protocol to transmit and receive the status information and the control information to control the building facilities to and from the remote and integrated building energy facility management apparatus.

The cable/wireless network interface 237 serves to transmit and receive the status information and the control information via a cable or wireless network.

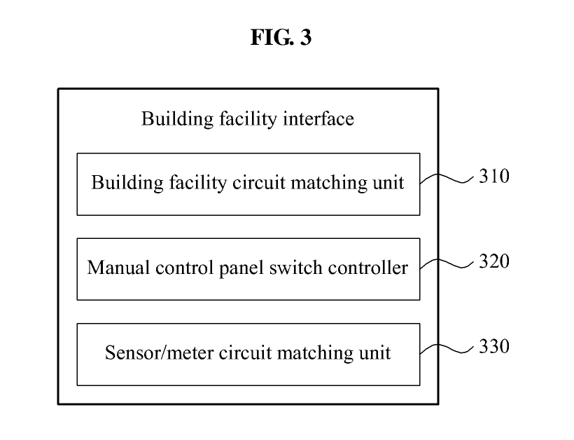

FIG. 3 illustrates a detailed configuration of a building facility interface according to an embodiment of the present invention.

Referring to FIG. 3, the building facility interface may include a building facility circuit matching unit 310, a manual control panel switch controller 320, and a sensor/meter circuit matching unit 330.

The building facility circuit matching unit 310 matches the control and alarm signals of the building facilities.

The manual control panel switch controller 320 controls the switches of the manual control panel according to control by the facility status controller.

The sensor/meter circuit matching unit 330 serves to match circuits of a sensor and a meter associated with the building facilities to accommodate various sensors and meters to identify environments associated with the building facilities.

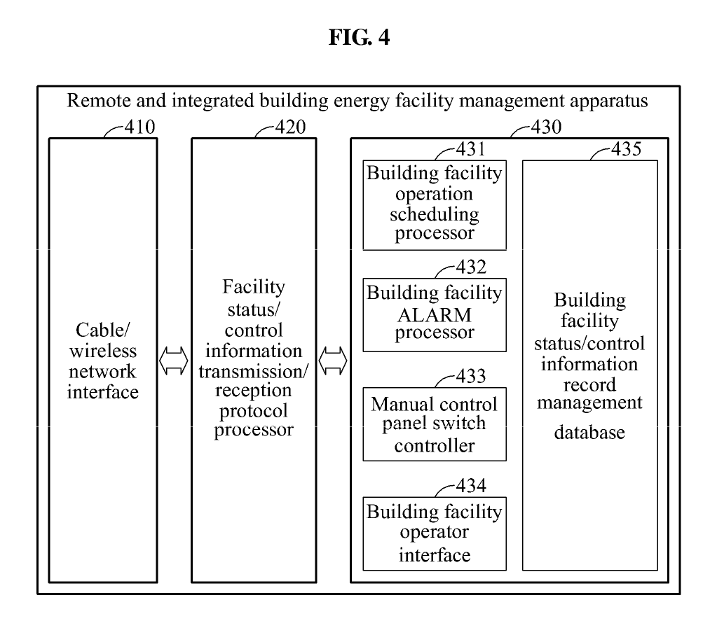

FIG. 4 illustrates a detailed configuration of a remote and integrated management apparatus according to an embodiment of the present invention.

Referring to FIG. 4, the remote and integrated management apparatus may include a cable/wireless network interface 410 and a facility status/control information transmission/reception protocol processor 420 to remotely communicate with a remote and automatic building energy facility control apparatus, a building facility operation scheduling processor 431 to manage a building facility through a remote and automatic building energy facility control apparatus by receiving status information from the remote and automatic building energy facility control apparatus and transmitting control information to the remote and automatic building energy facility control apparatus, a building facility alarm processor 432, a manual control panel switch controller 433, a building facility operator interface 434 and a building facility status/control information record management database 435.

The cable/wireless network interface 410 serves to transmit and receive status information on a building facility and control information to control the building facility to and from the remote and automatic building energy facility control apparatus, the status information being generated by the remote and automatic building energy facility control apparatus matching control and alarm signals of a manual control panel installed in a building to manage energy used in the building facility.

The facility status/control information transmission/reception protocol processor 420 processes a protocol to receive the status information from the remote and automatic building energy facility control apparatus through the cable/wireless network interface 410, and to transmit the control information to the remote and automatic building energy facility control apparatus in order to analyze and generate status/control information.

The building facility operation scheduling processor 431 manages an operation plan of the relevant building based on the received status information through the facility status/control information transmission/reception protocol processor 420.

The building facility alarm processor 432 processes an alarm situation of the relevant building facility based on the received status information through the facility status/control information transmission/reception protocol processor 420.

The manual control panel switch controller 433 generates control information based on the operation plan generated through scheduling of the building facility operation scheduling processor 431 and controls a switch of a manual control panel installed in the relevant building based on the control information.

The building facility operator interface 434 enables an operator to remotely manage the building facility.

The building facility status/control information record management database 435 stores a record of the status information and the control information on each building facility to manage the building.

An administrator of the remote and automatic building energy facility control apparatus may not only control the building facility through direct manipulation of the existing manual control panel of the building facility but also remotely manipulate the manual control panel of the building facility through the remote and automatic building energy facility control apparatus and the remote and integrated building energy facility management apparatus.

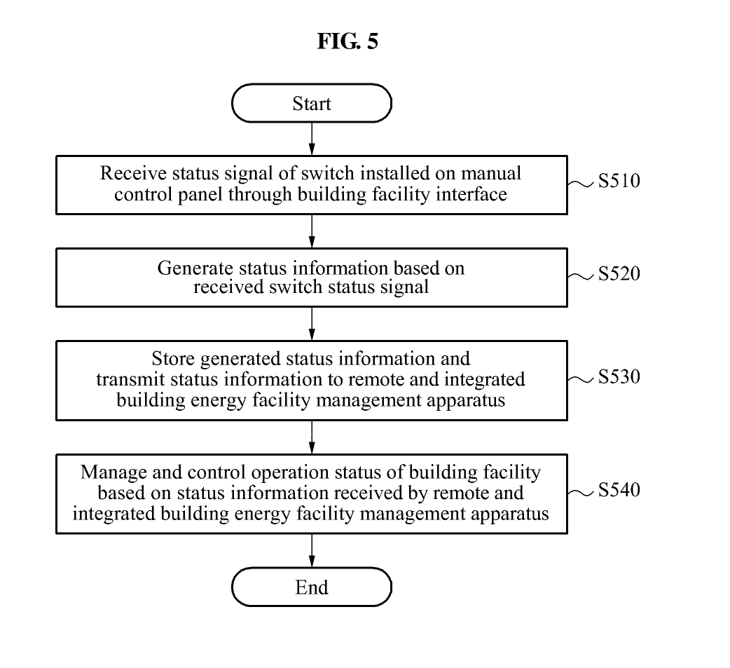

FIG. 5 is a flowchart illustrating a method for remotely and automatically controlling building energy facilities according to an embodiment of the present invention. Hereinafter, a process of collecting and controlling facility status information to manage energy used in a building is carried out as follows.

First, the building facility interface of the remote and automatic control apparatus reads a signal line connected to a building facility and a switch status (ON, OFF, or Alarm) signal of the manual control panel to match control and alarm signals of the manual control panel in operations S510.

Subsequently, the facility status information generator converts the matched control and alarm signals to generate status information on the building facility in a message form, in operation S520. The generated message is recorded in the facility status information storage/management unit and transmitted to the facility status information transmitter. Then, the message is formed into a communication packet for information exchange with the remote and integrated management apparatus and transmitted through the cable/wireless network interface to the remote and integrated management apparatus, in operation S530.

The remote and integrated management apparatus receives and analyzes the packet through the network and stores the status information on the building facility in the building facility status/control record management database. When the building facility is in an alarm situation, the remote and integrated management apparatus processes the alarm situation and determines an operation status of the building energy facility, in operation S540.

The remote and integrated management apparatus may provide various types of information to an operator through the building facility operator interface and the building facility status/control record management database, and determine a control status of the switches of the manual control panel of the building facility based on an operation plan of the building facility, generate a control packet and transmits the packet to the remote and automatic control apparatus through the building facility operation scheduling processor and the building facility switch controller.

When the packet is received through the network, the remote and automatic control apparatus analyzes a protocol and the facility status controller adjusts a status of the switches of the manual control panel of the building facility through the building facility interface based on a required control status and transmits a control signal based on a required operation of the building facility to operate the facility.

The system for remotely and automatically controlling the building energy facilities according to the present invention may be present in a building or disposed in remote locations from a building. Thus, the system may automatically and integratedly control building energy facilities regardless of locations.

Accordingly, the system and the method for remotely and automatically controlling building energy facilities according to the present invention may remotely and automatically performing a function of a manual control panel using a simple structure in a building environment where a building automation system (BAS) is not built without a person directly controlling a building facility through the manual control panel of the facility, remotely control the building facility even when an operator is not present at the site, and automatically operate the building facility based on an operation plan.

Further, the system and the method may remotely and automatically control the existing manual control panel without building an expensive direct digital controller (DDC) or BAS having sophisticated functions and construct a facility automation system enabling planned facility operation, which is hard to be realized by a manual control unit, thereby remarkably reducing construction costs.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for remotely and automatically controlling building energy facilities, the apparatus comprising:
a building facility interface to match control and alarm signals of a manual control panel installed in a building to manage energy used in a building facility and to control a switch of the manual control panel;
a facility status information generator to convert the matched control and alarm signals to generate status information on the building facility; and
a facility status controller to control the switch of the manual control panel based on the generated status information to remotely control an operation status of the building facility.

2. The apparatus of claim 1, wherein the building facility interface comprises:
a building facility circuit matching unit to match the control and alarm signals of the building facility;
a manual control panel switch controller to control the switch of the manual control panel based on control by the facility status controller; and
a sensor/meter circuit matching unit to match circuits of a sensor and a meter associated with the building facility.

3. The apparatus of claim 1, further comprising a facility status information storage/management unit to store and manage the generated status information.

4. The apparatus of claim 1, further comprising:
a facility status information transmitter to transmit the generated status information to an apparatus for remotely and integratedly managing building energy facilities which conducts remote and integrated management of a plurality of apparatuses for remotely and automatically controlling building facilities;
a facility status/control information transmission/reception protocol processor to process a protocol to transmit/receive the status information and control information to control the building facilities to/from the apparatus for remotely and integratedly managing the building energy facilities; and
a cable/wireless network interface to transmit/receive the status information and the control information through a cable/wireless network.

5. An apparatus for remotely and integratedly managing building energy facilities, the apparatus comprising:
a cable/wireless network interface to transmit and receive status information on a building facility and control information to control the building facility to and from an apparatus for remotely and automatically controlling building energy facilities, the status information being generated by the apparatus for remotely and automatically controlling the building energy facilities matching control and alarm signals of a manual control panel installed in a building to manage energy used in the building facility;
a facility status/control information transmission/reception protocol processor to process a protocol to receive the status information from the apparatus for remotely and automatically controlling the building energy facilities and to transmit the control information to the apparatus for remotely and automatically controlling the building energy facilities;
a building facility operation scheduling processor to manage an operation plan of the building based on the received status information;
a building facility alarm processor to process an alarm situation of the building facility based on the received status information;
a manual control panel switch controller to generate the control information based on the operation plan and to control a switch of a manual control panel installed in the building based on the control information;
a building facility operator interface to remotely manage the building facility; and
a building facility status/control information record management database to manage a record of the status information and the control information.

6. A system for remotely and automatically controlling building energy facilities, the system comprising:
a plurality of apparatuses for remotely and automatically controlling building energy facilities to generate status information on a building facility by matching control and alarm signals of a manual control panel installed in a building in order to manage energy used in the building facility; and
an apparatus for remotely and integratedly managing building energy facilities to control a switch of the manual control panel installed in the building by receiving the generated status information, managing an operation plan of the building based on the status information, generating control information based on the operation plan, and transmitting the control information to the apparatuses for remotely and automatically controlling the building energy facilities.

7. A method for remotely and automatically controlling building energy facilities which control a building facility to manage energy used in a building, the method comprising:
matching control and alarm signals of a manual control panel installed in the building;
converting the matched control and alarm signals and generating status information on the building facility; and
remotely controlling an operation status of the building facility based on the generated status information.

8. The method of claim 7, wherein the matching matches control and alarm signals of the building facility and circuits of a sensor and a meter associated with the building facility.

9. The method of claim 7, further comprising:
storing and managing the generated status information after the generating.

10. The method of claim 7, further comprising:
transmitting the generated status information to an apparatus for remotely and integratedly managing building energy facilities which conducts remote and integrated management of a plurality of apparatuses for remotely and automatically controlling building facilities; and receiving control information to control a switch of the building facility from the apparatuses for remotely and automatically the controlling building facilities after the generating,
wherein the controlling controls the switch based on the received control information.
